(19) United States
(12) Patent Application Publication
(10) Pub. No.: US 2005/0008003 A1
(43) Pub. Date: Jan. 13, 2005

(54) Method, apparatus, and article of manufacture for web-enabling telephony devices

(76) Inventors: K. Scott Ramey, Stittsville (CA); Craig Will, Fremont, CA (US); Larry David, Woodlawn (CA)

Correspondence Address: DOCKET CLERK, P.O. DRAWER 800889, DALLAS, TX, 75380, US

(21) Appl. No.: 10/808,092

(22) Filed: Mar. 24, 2004

Related U.S. Application Data
(63) Continuation of application No. 09/414,521, filed on Oct. 8, 1999, now abandoned.

(51) Int. Cl. H04L 12/66

(52) U.S. Cl. 370/352

(57) ABSTRACT

A method, apparatus, and article of manufacture for enabling a web application to communicate with a legacy telephony device. A communication channel is provided between the web application and the call server. Data transferred over the communication channel is translated to a form each can understand. Data transferred to the telephony device may be translated to telephony device data format and data transferred to the web application may be translated to wrapper API data format. An abstraction may be used to represent the telephony device, or to represent a class of telephony devices with similar characteristics. Data transferred to the telephony device may be mapped to a telephony device resource. Access to the telephony device may be arbitrated, and data coming from the telephony device may be routed. A service plugin may be provided to interface with a web application. An execution environment may be provided for dynamically adding a service plugin. The web application may be another web-enabled telephony device.

### I. BACKGROUND OF THE INVENTION

A. Field of the Invention

The present invention relates generally to networking telephony devices, and more particularly to methods, apparatus, and articles of manufacture for communication between a telephony device and a web application.

B. Description of the Related Art

A legacy telephone system typically includes a number of telephone sets coupled to a private branch exchange (PBX) by physical wiring. A call server resides in the PBX and handles many different call-related functions for the telephone sets. Call control functions, service control functions, and user interface functions are typically controlled by the call server. Although several of those call-related functions can be initiated by users of the telephone sets, many are generally inaccessible. More specifically, while the call server can be controlled by a limited number of commands available to a user, many additional commands can only be issued by system administrators using restricted access interfaces.

Call control functions, such as call connection, call disconnection, and connection of the members of a conference call, are typically performed by a call server in response to a command from a telephone set coupled to the telephone system. For example, such a command could be the act of dialing a telephone number. Service control functions, such as establishing a conference call, performing last number redial, and initiating a voice mail function can be performed by a call server in accordance with a “policy” applied to a user's telephone. A system administrator controls the policy, and thus controls which services are available to a user, by issuing commands to the call server through the restricted interface. Accordingly, users have a limited degree of control over the services available to them, which can typically be expanded only by contacting the telephone system administrator.

A need exists to expand the functionality of legacy telephone systems such that users thereof have greater control over their associated call server and telephone set. Thereby, users can access greater functionality without having to communicate requests to a telephone system administrator. Such a methodology increases the usefulness of legacy telephone systems by allowing them to be highly configurable by a user.

### II. SUMMARY OF THE INVENTION

Apparatus, methods, and articles of manufacture consistent with the principles of the present invention provide a method, apparatus, and article of manufacture for enabling communication between a web application and a telephony device. The web application and telephony device communicate over a channel that translates the data passing through it. In one embodiment, a wrapper program is used to translate the data consistent with the principles of the invention. The channel may be a control channel or a media channel. Data sent from the web application to the telephony device is converted to a telephony device data format, and data sent from the telephony device to the web application is converted to a wrapper API data format.

In one embodiment, an interface between the wrapper program and the web application uses an abstraction of the resources of a telephony device, or of a class of several different telephony devices having similar characteristics. Using the abstract resources, web application data can be mapped to actual resources. The interface also arbitrates access to a telephony device and rout data from a telephony device to a specific web application. Service plugins can also be used to provide an interface with web applications, and can run in a local execution environment. A web application may be standalone or the interface to another telephony device.

Another aspect of the present invention provides a system for web-enabling a telephony device. The system comprises a telephony device, a web application, and a wrapper program for providing a communication channel and translating data passing through the channel. The system functions whether the wrapper is integrated with the telephony device, or implemented remotely.

It is to be understood that both the foregoing general description and the following detailed description are exemplary and explanatory only and are not restrictive of the invention, as claimed.

### III. BRIEF DESCRIPTION OF THE DRAWINGS

The accompanying drawings, which are incorporated in and constitute a part of this specification, illustrate an embodiment of the invention and together with the description explain the advantages and principles of the invention.

FIG. 1 is a block diagram of a system for enabling a web application to communicate with a telephony device consistent with the principles of the present invention;

FIG. 2 is a flow chart of the steps performed by a method for enabling a web application to communicate with a telephony device consistent with the principles of the present invention;

FIG. 3 is a flow diagram showing a logical configuration consistent with the principles of the present invention;

FIG. 4 is a diagram of part of the user interface-of a telephony device which is communicating with a web application, consistent with the principles of the present invention; and

FIG. 5 is another diagram of part of the user interface of a telephony device which is communicating with a web application consistent with the principles of the present invention.

### IV. DETAILED DESCRIPTION

Reference will now be made in detail to an implementation of the invention as illustrated in the accompanying drawings. Wherever possible, the same reference numbers will be used throughout the drawings to refer to the same or like parts.

In the following description, for purposes of,explanation, numerous specific details are set forth in order to provide a thorough understanding of the principles of the present invention. One skilled in the art, however, will realize that the principles of the present invention may be practiced without these specific details. In other instances, standard structures and devices are shown in block diagram form in order to facilitate description.

The present application incorporates by reference the U.S. patent application of K. Scott Ramey, Michel Burger, and Larry David entitled METHOD, APPARATUS AND ARTICLE OF MANUFACTURE FOR WEB-BASED CONTROL OF A UNIFIED MULTI-PURPOSE COMMUNICATION SYSTEM filed on Oct. 8, 1999, attorney docket number 03384.0374-00000 and the U.S. patent application of K. Scott Ramey, and Michel Burger entitled METHOD, APPARATUS, AND ARTICLE OF MANUFACTURE FOR WEB-BASED CONTROL OF A CALL SERVER filed on Oct. 8, 1999, attorney docket number 03384.0372-00000.

In one embodiment, steps consistent with the principles of the present invention are embodied in machine-executable software-instructions, and the present invention is carried out in a processing system by a processor executing the instructions, as will be described in greater detail below. Those skilled in the art will recognize that other embodiments, for example hardwired circuitry, may be used in place of, or in combination with, software instructions to implement the present invention.

Telephony device, as used herein, is primarily a legacy voice communication device, such as a wired desk telephone or a mobile telephone, that is designed to be used with a legacy telephone system and which lacks the inherent ability to communicate with a web application. Apparatus and methods consistent with the principles of the invention act as an interface between a web application and a telephony device.

Web application, as used herein, is a device or computer program that provides data accessible over a network, such as an internet protocol (IP) network. For example, a web application may provide the results of a directory lookup, voice messages, stock quotations, or a streamed audio radio broadcast. In one embodiment, a web application is a remote service provider, such as a World Wide Web host. In one embodiment, a web application connects directly to the present invention's application program interface (API), whereas in another embodiment it lacks any capability to communicate with the present invention's API.

System Architecture

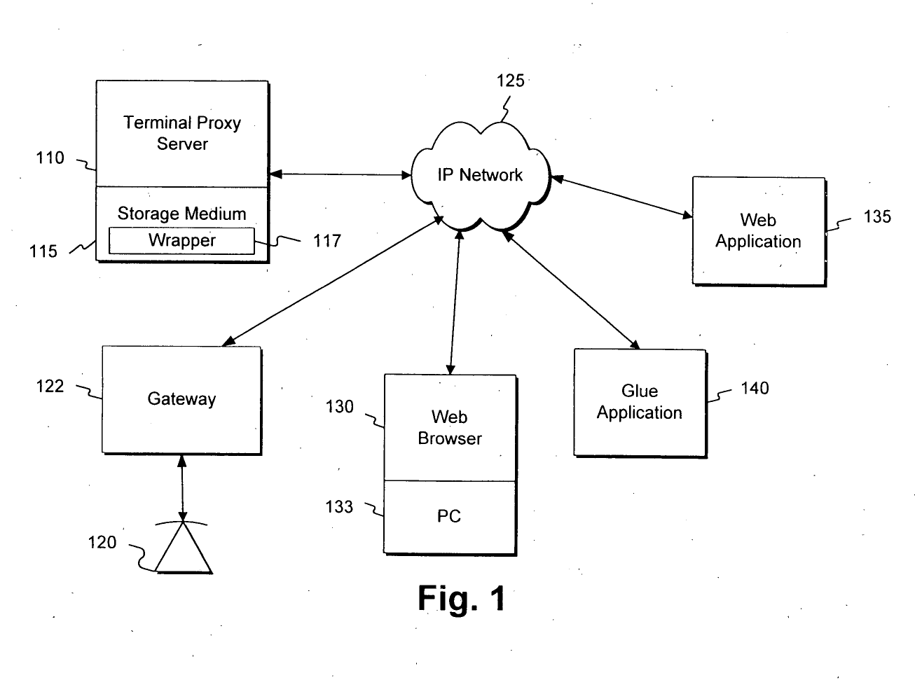

FIG. 1 shows a block diagram of a system for enabling a web application to communicate with a telephony device consistent with the principles of the present invention. The system enables a web application 135 to communicate with legacy telephony device 120 through a wrapper 117 executing on a terminal proxy server (TPS) 110.

Telephony device 120 is connected to a gateway 122. Telephony device 120 can be a standard legacy telephone, for example a wired desk telephone, which has no inherent capability to communicate over an IP network. Gateway 122 is a conventional high-speed computer system which functions to communicatively connect telephony device 120 to an IP network 125. Telephony device 120 could also be a legacy telephone which has the inherent capability to communicate over an IP network, such as a Nortel Model I2004 Etherphone. If telephony device 120 has IP capability, then it can be communicatively connected directly (not shown) to IP network 125 without gateway 122.

IP network 125 is a conventional IP network. For example, it may be a wide area network, such as the World Wide Web.

Terminal proxy server 110 is a conventional high-speed server computer, such as a workstation. TPS 110 is connected to IP network 125.

TPS 110 includes wrapper 117, which embodies the principles of the present invention. In one embodiment, wrapper 117 is a computer program stored on a storage medium 115. Wrapper 117 is aware of telephony device 120. Wrapper 117 executing on TPS 110 provides a communication channel between telephony device 120 and web application 135. Wrapper 117 enables web application 135 and telephony device 120 to transfer data back and forth with each other. One of ordinary skill in the art will recognize that wrapper 117 executing on TPS 110 does not have to be co-located with telephony device 120 as long as wrapper 117 is communicatively connected with telephony device 120 and IP network 125. Moreover, one skilled in the art will recognize that wrapper 117 may be implemented as part of telephony device 120, for example, as hard-wired circuitry.

Web application 135 is communicatively connected to IP network 125. Web application 135 produces data that is translated by wrapper 117 and transmitted to telephony device 120. For example, web application 135 may produce a ‘display text’ command and the text to be displayed.

Web browser 130 executing on PC 133 is also communicatively connected to IP network 125. A user of web browser 130 can access an application connected to IP network 125, such as web application 135 or glue application 140, by, for example, using a universal resource locator (URL).

Glue application 140 is communicatively connected to IP network 125. Glue application 140, which embodies the principles of the present invention, provides an interface between web application 135 and wrapper 117, allowing web application 135 and wrapper 117 to communicate. Glue application 140 may also provide a user interface, such as a graphical user interface (GUI), for controlling web application 135 and wrapper 117. One of ordinary skill in the art will realize that glue application 140 could be located anywhere in the system where it can communicate with both web application 135 and wrapper 117. For example, glue application 140 could be implemented as a service plugin of wrapper 117 executing on TPS 110, instead of standalone as shown in FIG. 1. One skilled in the art will also appreciate that web application 135 may be designed to communicate directly with wrapper 117, making glue application 140 unnecessary.

In another embodiment, the present invention enables peer-to-peer communication between telephony devices, each of which communicates through a wrapper. In this embodiment, the wrapper of each telephony device is just a web application to the wrapper of the other telephony device. In this embodiment, web application 135 is another wrapper, similar to wrapper 1 17, which enables telephony device 120 to communicate with a second telephony device (not shown) associated with web application 135.

Listening to Web Radio

For purposes of example, assume web application 135 is an audio broadcast web site, hosted on a web server, which uses standard protocols for media transport and control, such as real time signaling protocol (RTSP). Further assume that telephony device 120 is a desk telephone containing a speaker and is able to receive an RTP audio stream, and that PC 133 running web browser 130 is co-located with telephone 120.

First, using web browser 130, a user loads glue application 140 as, for example, a Java applet. Glue application 140 provides an interface between audio web application 135 and wrapper program 117. Glue application 140 is telephony device specific and web application specific. That is, glue application 140 is specifically designed to communicate with the interface of wrapper program 117 and the interface of web application 135.

Next, using web browser 130, the user accesses and loads web application 135, for example, in the form of a Java applet. Web application 135 executing on web browser 130 provides a GUI that allows the user to select an audio program, for example a foreign radio station broadcast. Web application 135 functions conventionally and commands PC 133 to open a sound interface as the destination of the selected audio stream from the foreign radio station broadcast. Web application 135 initiates an RTSP open stream from a broadcast source to PC 133's sound interface. The audio does not go to the PC 133's sound card, however, because glue application 140 replaces the standard PC sound interface and redirects the audio stream.

Glue application 140 allows the user to choose the audio speaker on telephone 120 as the destination for the- audio stream. Glue application 140 receives web application 135's control command to open a sound interface, translates the command into a request for an audio stream resource in accordance with the API of wrapper 117, accesses wrapper 117, for example using a remote procedure call, and transmits the request to wrapper 117. In response to the resource control request, wrapper 117 arbitrates, if necessary, access to the appropriate resources of telephone 120. Then wrapper 117 translates the API request into a telephony device command and transmits it to telephone 120 to open a streamed audio connection in receive only mode. Thus, wrapper 117 and glue application 140 provide a communication channel between web application 135 and telephony device 120, and translate web application 135's control commands into telephony device control commands.

Telephone 120 supports RTP streamed audio format, so the web application streamed audio media data must be converted to RTSP format before telephony device 120 can play it. In this example, glue application 140 converts web application 135's streaming audio data from RTSP to RTP format and transmits the converted data to telephony device 120. The user hears the foreign radio station broadcast over the audio speaker of telephone 120. One of ordinary skill in the art will recognize that converting the audio media data format can be done by an application other than glue application 140, without departing from the scope of the present invention. For example, wrapper 117 or an independent web application (not shown) hosted on a website connected to IP network 125, can perform the conversion. One of ordinary skill in the art will also recognize that if web application 135 produces audio media data in a format that telephony device 120 supports, here, RTP format, then the media path could connect directly to telephone 120 through gateway 122, bypassing glue application 140.

The Wrapper

To communicate, web application 135 and telephony device 120 have a communication path between them and may use the same API or have a translator. Apparatus and methods consistent with the principles of the present invention provide a communication channel between web application 135 and telephony device 120 over IP network 125 and translate data transferred between web application 135 and telephony device 120 into formats each understands.

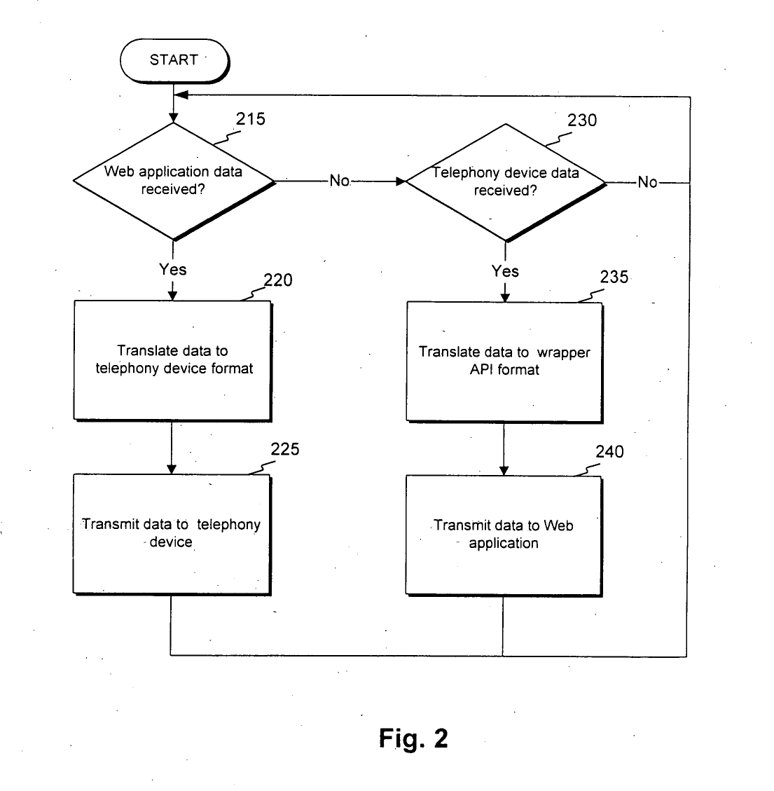

FIG. 2 is-a flow chart of the steps performed by wrapper program 117 consistent with the principles of the present invention. Wrapper program 117 first determines whether any data was received from web application 135 (step 215). If web application data was received, wrapper program 117 translates the data from a wrapper API format to a telephony device data format (step 220) and transmits the translated data to telephony device 120 (step 225). Wrapper API format is a format that wrapper program 117 can receive and understand, which is used by an entity, such as glue application 140, communicating with wrapper 117. Telephony device data format is a format telephony device 120 understands.

If no web application data has been received (step 215), wrapper program 117 determines whether telephony device data was received from telephony device 120 (step 230). If telephony device-data was received, wrapper program 117 translates the data from telephony device data format to wrapper API format (step 235) and transmits the translated data to web application 135 (step 240). Processing then continues with wrapper program 117 determining whether web application data has been received (step 215).

Logical Configuration

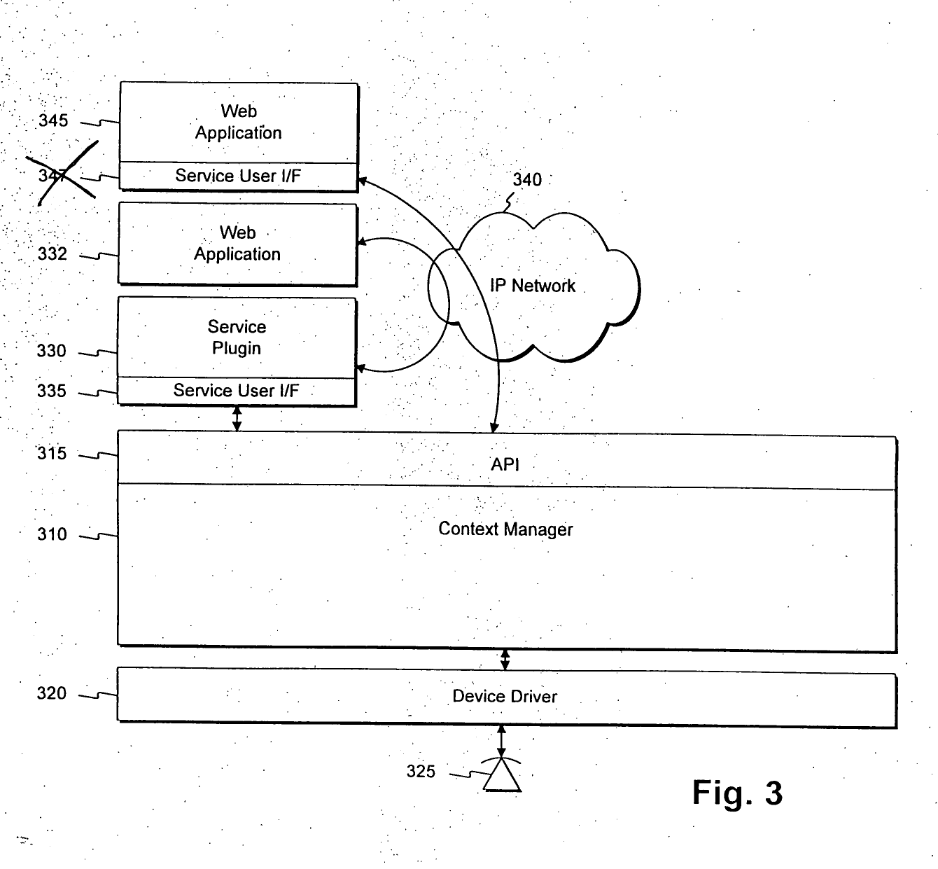

One embodiment of the present invention is composed of logical components as shown in FIG. 3. More particularly, the embodiment is composed of a device driver 320, a context manager 310, and a service plugin 330. FIG. 3 illustrates one configuration of software components consistent with the present invention. Those of ordinary skill in the art will recognize that the software configuration of FIG. 3 is only one possible embodiment of the present invention, and that modifications may be made without departing from the principles of the present invention.

Wrapper—Telephony Device Interface

The present invention provides web-accessability to legacy telephony devices with little or no modification to the legacy devices. To do this, device driver 320 communicates with telephony device 325 using a telephony device data format. Telephony device 325 defines the telephony device data format. That is, the interface for telephony device 325 specifies the format of the data communicated between telephony device 325 and device driver 320. Device driver 320 converts web application data into a telephony device data format before transmitting the converted data to telephony device 325. Similarly, device driver 320 converts telephony device data into a wrapper API data format before passing the converted data to context manager 310.

The telephony device data formats used by existing telephony devices are well known in the art. Generally, telephony devices use a well defined communications protocol, such as MEGACO or H.248.

Web Application Program Interface

The present invention also provides a simple user interface for a telephony device, so that a wide variety of web applications can easily access a device without knowledge of the device's specific operating details. Wrapper 117's context manager 310 contains a web application program interface (API) 315 for communicating, either directly or indirectly, with a web application.

The wrapper API 315 defines the wrapper API data format. That is, the wrapper API 315 specifies the format of the data communicated between a web application, such as web application 345, and the present invention. In one embodiment, if a web application such as web application 332 does not communicate in wrapper API data format, then a service plugin 330 translates web application 332's native format into wrapper API data format. Web application 332 and service plugin 330 are analogous to web application 135 and glue application 140 in FIG. 1.

In one embodiment, wrapper API 315 uses an abstraction to represent the resources of telephony device 325. The abstraction generalizes the telephony device's capabilities and resources. For example, wrapper API 315 may abstract the two line, LCD, text-only display resource of a telephony device into a general display resource able to handle any amount or type of display data. Using this abstraction, wrapper API 315 accepts multi-line text and picture data sent to the abstract display resource by a web application, even though telephony device 325 is incapable of displaying more than two lines at a time, and is incapable of displaying pictures. Abstraction provides the advantage of allowing a web application to send display data without custom formatting the data for the-telephony device. The actual workings of the telephony device are hidden from a web application, which sees only the abstraction provided by the API.

In another embodiment, the present invention uses an abstraction representing a class of telephony devices with similar characteristics, for example PBX phones, analog phones, and browser phones. The class members are physically different types of telephony devices, but they are enough alike to be represented by a single abstraction at the API level. Using a single abstraction to represent a class of telephony devices provides the advantage of allowing a single web application or service plugin to communicate with all the different devices in a class using the same API. This saves the cost of creating a customized web application or plugin for each telephony device within a class.

Context Manager

Although it is possible to use an abstraction and present a simple API to web applications, the data received through an abstracted API generally cannot be directly used by a telephony device. In one embodiment, the invention maps the abstract data to the telephony device's resources to solve this problem. Mapping involves configuring the data transferred by a Web application to an abstract device resource into a form that can be utilized by the telephony device resource. In an embodiment using an abstraction to represent a class of telephony devices, the invention keeps track of which devices among those in the class are connected, and maps web application data according to each device's actual resources.

Referring again to FIG. 3, and recalling the previous example, web application 345 communicating through API 315 can send multi-line text and picture data to an abstract display resource, even though the actual telephony device is incapable of displaying more than two lines at a time, and is incapable of displaying pictures. In this case, context manager 310 maps the data to the actual two line display resource of telephony device 325 by, for example, displaying two lines of the text each time the user presses a keypad button, and discarding the pictures. The mapping function is invisible to web application 345. Configuring the data into two line pieces and displaying more data in response to keypad inputs are performed internally by context manager 310.

Telephony device 325 may have several resources. A common office telephone, for example, may have a speaker resource, a two line display resource, a number keypad resource, and function keypad resource. In one embodiment, the present invention arbitrates access to a telephony device's resources, so that two or more web applications may share the resources of a single telephony device. To arbitrate, the invention keeps track of the state of each web application and telephony device resource and decides which web application may use a resource at a given moment. For example, web application 345 may be using telephone device 325's two line display, when a second web application 332 tries to write data to the same display. The context manager 310 arbitrates access to the two line display, holding the second web application's data until the first web application finishes using the display.

For data moving in the other direction, one embodiment of the present invention routes stimulus data coming from a telephony device to the proper web application. In this embodiment, the present invention keeps track of which stimulus resources belong to which web application, and directs stimulus inputs to web applications accordingly. For example, wrapper API 315 for telephony device 325 may contain a speaker resource and a display resource. Web application 345 may use the display resource to show a string of real time stock quotes requested by a user. At the same time, web application 332 may use the speaker resource to stream broadcast news audio. If, for example, the stock quotation web application recognizes keypad strokes “#9” as a command to stop providing quotations, and the telephony device user presses “#9,” then context manager 310 routes the “#9” stimulus data or an equivalent command string to, the stock quotation web application rather than to the streaming audio web application.

Service Plugins

In another embodiment of the invention, if a web application cannot communicate with API 315 in wrapper API data format, then a service plugin 330 between API 315 and the web application allows the web application and API 315 to communicate. A service plugin is a custom interface that is wrapper API-specific and web application-specific. For example, if a web application is designed to stream audio to a sound card on a PC hosting a web browser which accessed the web application, such a web application does not have information regarding communication with the present invention's API, which includes, for example, an abstraction of a telephone's audio speaker. To stream the web application's audio data to the telephone's speaker, the service plugin receives the setup control data transmitted by the web application, converts it into API data format, and sends it to the API for preparing the telephone's speaker to accept a streamed audio data connection.

Returning to FIG. 3, service plugin 330 provides an interface for web application 332. Web application 332 sends data to service plugin 330 in the web application's native data format and protocol. Service plugin 330 converts from the web application's native data format to data objects defined by the service plugin. Service plugin 330 takes the data objects and issues requests to the context manager 310 through the API 315. For data sent from telephony device 325, context manager 310 issues requests to service plugin 330 through service user interface 335. Service user interface 335 provides a telephony device-specific user interface for web application 332. Service plugin 330 converts the requests to the web application's native data format, and sends the data to web application 332.

In another embodiment, a service plugin is implemented as an optional plugin to the present invention. The optional plugin is only included if a user desires a telephony device to communicate with the specific web application that the service plugin is customized for. In this embodiment, an execution environment is provided for a service plugin. The execution environment allows a software application to function on a host system. For example, the present invention may provide a JAVA™ virtual machine for executing service plugins implemented as JAVA™ plugins.

One skilled in the art will recognize that a service plugin may be implemented anywhere in a network system as long as it can communicate with API 315 and a web application, without loss of compatibility with the present invention. In one embodiment, a service plugin is hosted remotely from the computer hosting wrapper 117. Glue application 140 in FIG. 1 is an example of a remotely hosted service plugin. Glue application 140 functions the same as a locally hosted service plugin, as described above, but communicates with wrapper 117's API 315 over IP network 125.

In yet another embodiment, service plugins may interact with each other, as well as with API 315.

Stock Quote Application

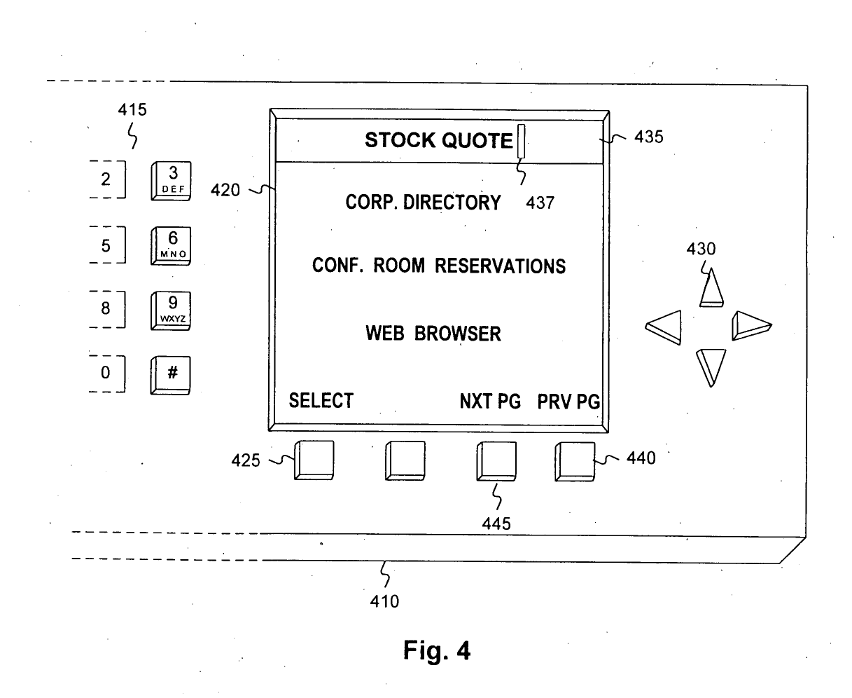

The invention will be further clarified by the following example, which is intended to be purely exemplary of the invention. This example illustrates how the user interface of a legacy telephone can be used to communicate with a web application. For purposes of example, telephony device 120 is a legacy telephone with a five-line display and associated controls, such as a Nortel model i2004 telephone. FIG. 4 illustrates a portion of the user interface of a legacy telephone 410 with a five-line display. The right side of telephone 410 contains a five-line display 420, four softkeys, such as softkey 425 underneath display 420, and four cursor control keys 430 to the right of display 420. A telephone keypad 415 to the left of display 420 is partially shown in FIG. 4. A handset and speaker to the left of telephone keypad 415 is not shown.

Five-line display telephone 120 is a low-cost legacy set, such as a stimulus set. The contents of display 420 are generated by wrapper 1 17 executing on TPS 110. When a softkey such as softkey 425 is pressed, telephone 120 merely sends stimulus data in telephony device data format to wrapper 117, which performs a function associated with the softkey.

For instance, FIG. 4 shows an example of a top-level menu that allows a user to select a web application to run from the user interface of telephone 410. Display 420 shows a STOCK QUOTE application, a CORPORATE DIRECTORY application, a CONFERENCE ROOM RESERVATIONS application and a WEB BROWSER application. Softkey 445 allows a user to display the next four web applications available from telephone 410, and softkey 440 allows a user to display the previous four web applications displayed. Cursor control keys 430 allow a user to move a cursor 437 on screen 420 up, down, left, and right. When the cursor is on a line, the line is highlighted 435. To run a web application, a user moves cursor 437 to highlight 435 the application, then presses softkey 425 to SELECT the application.

In response, wrapper 117 runs a service plugin which may be a remotely hosted or locally hosted. Consider, for example, wrapper 117 running a stock quote service plugin. The stock quote plugin changes the display 420 on telephone 410 by prompting the user to enter a stock symbol (not shown). The user enters a symbol using telephone keypad 415 and softkeys such as softkey 425. For example, to enter the stock symbol “FEN,” a user presses the “3” key three times to display a letter “F,” then a softkey to select “F,” presses the “3” key two times to display a letter “E,” then a softkey to select “E,” and presses the “6” key two times to display a letter “N,” then a softkey to select “N.” When the stock symbol is completed, the user presses an appropriate softkey to signify completion.

In response, the stock quote plugin acts in a conventional manner to get stock information from a web application hosted on a website. For example, assume that web application 135 is a stock quote web application; wrapper 117 accesses web application 135 across IP network 125 using a URL. The stock quotation plugin of wrapper 117 is specifically designed to interact with web application 135. Wrapper 117 sends a request for stock information to web application 135, for example as a CGI script using the stock symbol entered by the user as a search parameter. In response, web application 135 sends the current stock price as well as various other standard information, such as change in price, 52 week high and low price, and volume traded.

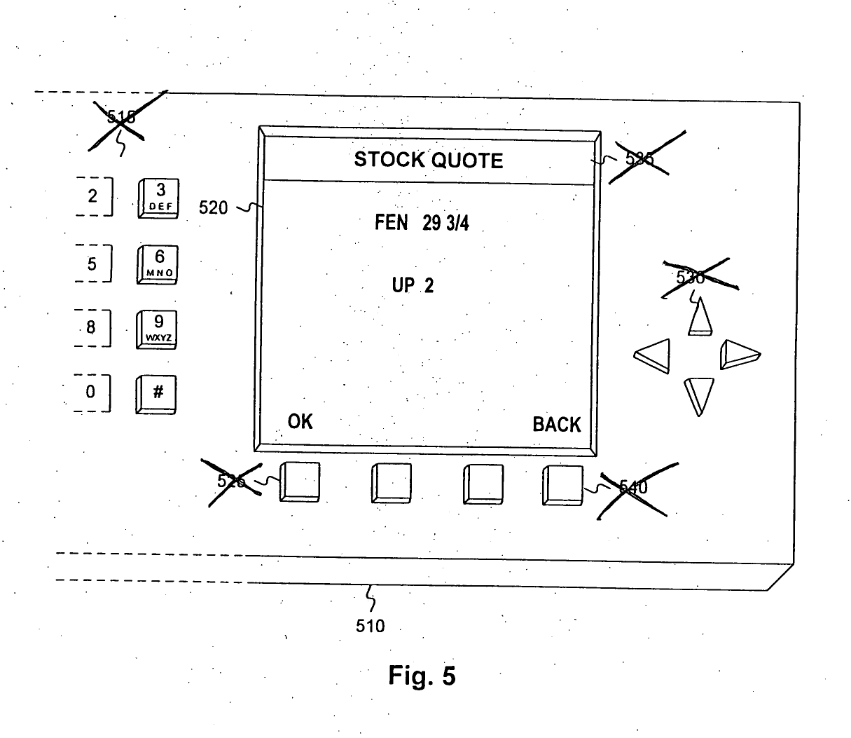

Wrapper 117 receives all the-stock data and formats the price and change information for the five-line display of telephone 120. The remainder of the data is discarded. Wrapper 117 translates the stock price and change data to display control data for telephone 120, and transmits the converted data. As shown in FIG. 5, telephone 510 displays the price and change data on five-line display 520 for the user to see.

Web Browser

In one embodiment, wrapper 117 executing on TPS 110 includes a web browser component implemented as a service plugin. The web browser component understands a common standard interface, which allows it to communicate with web applications written with the same standard interface. For example, the web browser service plugin may understand Handheld Device Markup Language (HDML), Wireless Markup Language (WML) or Hyper Text Markup Language (HTML). To illustrate, assume a website running web application 135 provides real-time traffic information in WML to an IP network 125. Assume further that another website runs a web application (not shown) that provides Federal Express (sm) package traffic information in WML. Telephony device 120 can access both web sites using a wrapper 117 that contains a WML web browser service plugin, with no need for a custom glue application such as glue application 140 for each.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-63. (Canceled)

64. A method for enabling a web application to communicate with a telephony device, comprising:
providing a communication channel between the web application and the telephony device; and
translating web application data from the web application into a telephony device data format of the telephony device.

65. The method of claim 64 wherein translating web application data further comprises:
translating web application control data from the web application into a telephony device control data format of the telephony device.

66. The method of claim 65 wherein translating web application data further comprises:
translating web application media data from the web application into a telephony device media data format of the telephony device.

67. The method of claim 64 further comprising:
using a telephone device abstraction.

68. The method of claim 67 wherein using a telephony device abstraction further comprises:
using an abstraction for a class of telephony devices.

69. The method of claim 64 further comprising:
routing data transferred between the telephony device and the web application; and
arbitrating access to the telephony device.

70. The method of claim 64 further comprising:
providing a service plugin.

71. The method of claim 64 further comprising:
mapping the data to a telephony device resource.

72. The method of claim 64 further comprising:
converting telephony device data to a wrapper API data format.

73. The method of claim 64 wherein the web application is another wrapper.

74. An apparatus for enabling a web application to communicate with a telephony device comprising:
means for providing a communication channel between the web application and the telephony device; and
means for translating web application data from the web application into a telephony device data format of the telephony device.

75. The apparatus of claim 74 wherein the means for translating web application data further comprises:
means for translating web application control data from the web application into a telephony device control data format of the telephony device.

76. The apparatus of claim 75 wherein the means for translating web application data further comprises:
means for translating web application media data from the web application into a telephony device media data format of the telephony device.

77. The apparatus of claim 74 further comprising:
means for using a telephony device abstraction.

78. The apparatus of claim 77 wherein the means for using a telephony device abstraction further comprises:
means for using an abstraction for a class of telephony devices.

79. The apparatus of claim 74 further comprising:
means for routing data transferred between the telephony device and the web application; and
means for arbitrating access to the telephony device.

80. The apparatus of claim 74 further comprising:
means for providing a service plugin

81. The apparatus of claim 74 further comprising:
means for mapping the data to a telephony device resource.

82. The apparatus of claim 74 further comprising:
means for converting telephony device data to a wrapper API data format.

83. The apparatus of claim 74 wherein the web application is a wrapper.

84. A computer program product comprising:
a computer usable medium having computer readable code embodied therein for enabling a web application to communicate with a telephony device, comprising,
computer readable code for causing a computer to provide a communication channel between the web application and the telephony device, and
computer readable code for causing a computer to translate web application data from the web application into a telephony device data format of the telephony device.

85. The computer program product of claim 84 wherein the computer readable code for causing a computer to translate web application data further comprises:
computer readable code for causing a computer to translate web application control data from the web application into a telephony device control data format of the telephony device.

86. The computer program product of claim 85 wherein the computer readable code for causing a computer to translate web application data further comprises:
computer readable code for causing a computer to translate web application media data from the web application into a telephony device media data format of the telephony device.

87. The computer program product of claim 84 further comprising:
computer readable code for causing a computer to use a telephony device abstraction.

88. The computer program product of claim 87 wherein the computer readable code for causing a computer to use a telephony device abstraction further comprises:
computer readable code for causing a computer to use an abstraction for a class of telephony devices.

89. The computer program product of claim 84 further comprising:
computer readable code for causing a computer to route data transferred between the telephony device and the web application; and
computer readable code for causing a computer to arbitrate access to the telephony device.

90. The computer program product of claim 84 further comprising:
computer readable code for causing a computer to provide a service plugin.

91. The computer program product of claim 84 further comprising:
computer readable code for causing a computer to map the data to a telephony device resource.

92. The computer program product of claim 84 further comprising:
computer readable code for causing a computer to convert telephony device data to a wrapper API data format.

93. The computer program product of claim 84 wherein the web application is a wrapper.
